(19) United States
(12) Patent Application Publication
(10) Pub. No.: US 2020/0007075 A1
(43) Pub. Date: Jan. 2, 2020

(54) COMPATIBLE, UNIVERSAL, INTERACTIVE SOLAR ROOFING SYSTEM FOR THE ECONOMIC GENERATION OF ELECTRIC POWER, AND PROCESS FOR ACCOMPLISHING THE SAME

(71) Applicant: Miklos Somogyi, Clearwater, FL (US)

(72) Inventor: Miklos Somogyi, Clearwater, FL (US)

(21) Appl. No.: 16/459,398

(22) Filed: Jul. 1, 2019

Related U.S. Application Data
(60) Provisional application No. 62/691,644, filed on Jun. 29, 2018.

(51) Int. Cl. H02S 20/25; H02S 40/34

(52) U.S. Cl. CPC H02S 20/25; G09F 13/005; H02S 40/34

(57) ABSTRACT

The present invention pertains to a compatible, universal, next-generation interactive solar roof tile system for the economical production of electric energy from an external light source in such a way that the flat surface of the roof tile body (1) has a solar layer (6) containing solar cells, the solar layer (6) is covered with a sun-permeable protective layer (8), the solar cells are equipped with integrated conductors (2) and connectors (4), wherein the outer dimensions of the roof tile are compatible with those of the majority of previously produced tiles, and it has a substrate tile body (1) manufactured according to the desired shape and size. The heat and frost-resistant basic material of the roof tile is made of non-combustible composite or recycled materials or a combination of those. On flat surfaces and on convex or concave surfaces the solar cells and solar layers (6) are series or parallel connected in the form of strips with standards-compliant conductors and electric shock-protected connectors, as well as the substrate tile body (1) has a fixed on fire resistant heat-insulating layer (5). The solar cell layers (6) are connected to an interactive, integrated LED lighting device (7) equipped with a control unit to allow displaying of images, advertising signages and digital visualisation.

### CROSS REFERENCE TO RELATED PATENT APPLICATION

This application claims priority to provisional U.S. Application No. 62/691,644, filed Jun. 29, 2018, the contents of which are herein incorporated by reference in their entirety.

### FIELD OF THE INVENTION

The present invention pertains to an interactive solar roofing system that generates electric power from an external light source.

### BACKGROUND OF THE INVENTION

Known devices used for similar purposes include solar panels which, when installed over roofing elements (tiles/shingles) produce an electric current. The drawback of this solution is that the panels cannot be installed on every type of building, do not meet the aesthetic objectives set for the present invention, are not permitted for installation on many historic buildings, and are not adequately efficient, and therefore do not pay for themselves for many years.

The closest solution to that of the present invention is described in Hungarian patent number P0700773, entitled “Solar Roofing Tile for the Generation of Electric Energy and Procedure for its Production”.

In essence, this known invention consists of “an electric power generating solar roof tile whose outer surface is fitted with solar cells where the solar cells are equipped with conductors and connectors. The solar cell roof tile possesses a substrate made from plastic or synthetic resin formed into the appropriate shape and size and a flexible solar cell layer containing solar cells applied to the outer surface of the substrate, there are conductive rails and connectors in and/or on the surface of the substrate, furthermore the solar cell layer is either directly or via a conductive stud connected to the conductive rails, and the solar cell layer is sealed in a waterproof manner by a transparent protective layer that tightly conforms to the shape of the outer surface of the substrate.”

The deficiency in the above solution is that it applies, by either an adhesive or direct incorporation, a flexible solar layer, i.e. a power-generating membrane, to the surface of the plastic tile, such that the solar layers are connected by means of cables and cable junction boxes, which from a technical or engineering standpoint does not comply with electric shock protection and photovoltaic standards. Another deficiency is that the flexible solar units have a low efficiency and cannot produce power economically. Other types of solutions have similarly represented only partial successes and rudimentary attempts.

### SUMMARY OF THE INVENTION

The present invention pertains to a compatible, universal, next-generation, interactive solar roofing system that economically generates electric power from an external light source, along with the process used to accomplish this, which process arose from the continued development of earlier systems and the elimination of their deficiencies, different from any other known methods, focusing on the external size of the tile, and it is manufactured to the external dimensions of many world known tile varieties. The roof tiles according to the present invention are created with solar cells, and are fully compatible with original, normal roof tiles and can be easily replaced at the site by replacing the existing tiles without any technical intervention in the roof structure, and are considerably more advanced than the solutions given by earlier publications in terms of efficiency, construction, and functionality alike.

With the present invention, the objective was that a universal, next-generation interactive photovoltaic roofing system should be suited to the economic production of electric power from external light sources, whether natural light (sunlight), or artificial light, heat, or cosmic radiation, made from a completely different base material from previous systems and including new technical solutions and connectors that are both safe and, at the same time, compliant with existing standards, thus providing it with new properties, such as heat insulation, in colors as desired, rounded out with multiple new expandable functions and a range of applications suited to the present age. The system should be able, through the use of the stored electrical energy it collects, to emit white or colored light over the entire surface of each solar roofing unit (or a portion thereof), whereby the light-emitting units are preferably LED, neon, fluorescent, or incandescent bulbs. The new solution according to this invention, unlike previous solutions found throughout the world to date, places the realm of solar roofing units into an entirely new dimension. Another important objective was that the solar roofing units, using solutions to improve their output, should operate economically and thus pay for themselves in a short period of time.

In the course of developing the system according to this invention, it is understood that if silicon-based, inflexible poly- or multi-crystalline photovoltaic cells are used, either by incorporating them into, or installing them onto the flat or curved (convex or concave) surfaces of roofing tiles, such that the inflexible photovoltaic cells are sliced into strips for attachment, and if, for this reason, the surface of the primary body of the roof covering (tile) is formed into planar ribs over the convex or concave surface according to the sizes of the strips of the sliced solar cell, then said ribs will cause an increase in the surface area of the convex or concave surface. The individual flat photovoltaic wafer strips incorporated into the ribs are connected to each other in series, preferably by welding, thus creating a new generation of solar roofing tiles with a completely unified electric-power-supplying surface, and increasing the electrical voltage of each cell. Because with this solution, a high nominal voltage can be produced on each (planar, non-planar, or geometric) roofing unit, the improved efficiency according to the set objective can be met.

### BRIEF DESCRIPTION OF THE DRAWINGS

The solution according to this invention is described in greater detail in the following drawings:

FIG. 1 shows the cross-sectional view of the primary body where the variously sized silicon wafers (strips of various widths) are integrated onto the flat or curved surfaces. FIG. 1 includes a 1 tile body, 2 integrated conductors, a 3 pocket, 4 connectors, a 5 heat-insulating layer integrated into the primary body, on the outer surface a 6 solar cell layer (PV Wafer strips) where each strip contacts the primary body over its entire surface. FIG. 1 also shows a 7 lighting device which is a LED, and a 8 protective layer over the surface of the 6 solar cell layer.

FIG. 2 shows the top view of the tile with 7 lighting devices aligned on a row.

FIG. 3 shows the bottom view of the tile with the 3 pocket and 4 connectors.

FIG. 4 shows an application of light-emitting, pixel-system roof tiles, depicting the position of 7 lighting devices (LEDs).

FIG. 5 shows a sandwich panel.

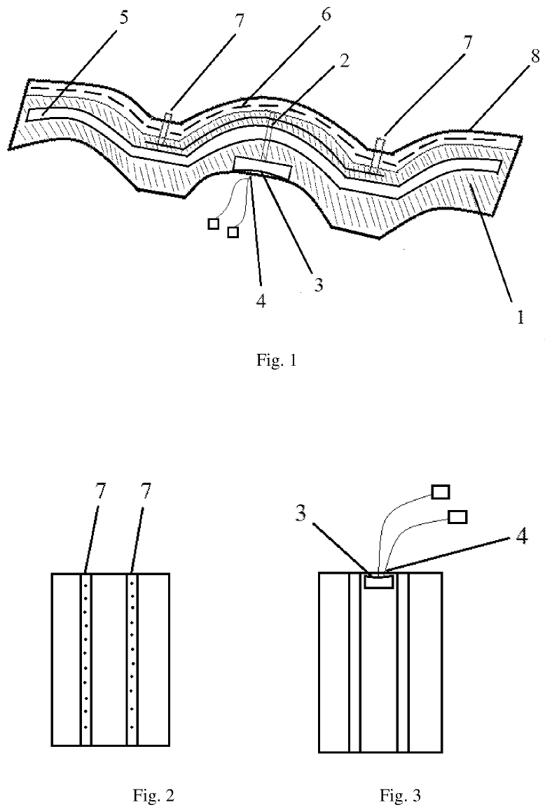

### LIST OF REFERENCE SIGNS

1 tile body

2 integrated conductors

3 pocket

4 connectors

5 heat-insulating layer

6 solar cell layer (PV Wafer strips)

7 lighting device

8 protective layer

### DETAILED DESCRIPTION

One of the most important features of the incorporation of the variously sized silicon wafers (strips of various widths) onto the non-planar surfaces of the primary body is that the contact surfaces be flat, so that each sliced silicon strip contacts the primary body over its entire surface, and thus the strips meet technical standards from the standpoints of both physics and static engineering, i.e. are physically and statically “unbreakable”. This feature is illustrated by the cross-sectional view given in FIG. 1.

Given the widespread use today of various small and large electronic surfaces, LED displays, and audio-visual screens, means of communicating information that have become part of our lives at the global level, the inventor realized that in the new solution according to the present invention, this digital visualization could be extended to the roofs of private homes, too, allowing for customization of roofs, such as for advertising businesses, and displaying various Christmas or other holiday images through an LED system integrated into types marketed under the next generation or other names The color rooftop images and text may be controlled by smart phone or computer, with arbitrary images and text sent directly to the roofs as giant color display screens. Such intelligent solar roofing units or tiles may use part of the electric power they generate and store to display the images at night, off-grid.

The above considerations all contributed to the design of a complete roofing system according to the present invention. This next-generation solar roofing system constitutes an advanced technology and, in terms of use, an assemblage of new solutions and systems, as outlined below, as compared to previous solar roofing systems.

Each power-generating roofing unit can be made into any form, shape, size, or color, including those associated with a conventional roofing unit. Units can have a planar, waveform, concave, convex, polygonal, or trapezoidal geometry and can be used in combination to form repeating patterns.

The base material of the primary body of the next-generation solar roof covering may be any of a wide variety of substances, composite, any petroleum-derivative-based plastic or artificial resin, or the combination of any of these with any other mineral substance (sand or ground rock), fibreglass, carbon fibre, or ground glass; composite, or of recycled materials.

Structurally, units may be completely transparent or completely opaque, or made such that full or partial transparency may be adjusted either directly, or by electronic remote control. The electric power produced from light may provide direct or alternating current, depending on type and construction. The next-generation solar roofing tiles may also be connected in series, or in parallel, depending on type.

The roofing system according to the present invention includes integrated conductive cables which are placed into a cable junction box. The solar roofing units produced in this way can be joined to each other at their edges, so that transmission of the electric power produced in individual units is accomplished via integrated conductive connectors as the system desires. The conductive material incorporated into the solar tiles (roofing units) is made using a special, electrically conductive composite base material that can be incorporated using module technology in a single work phase of the manufacture of the primary body, so that conductive and non-conductive structural elements form a single unit.

The next-generation solar roofing system represents an advanced technology and, in terms of use, an assemblage of new solutions and additional variations, as outlined below, as compared to previous solar roofing systems.

The colors of the lights and appearance of the surface can be adjusted either directly, or by remote control. The power for the emitted light can be provided by, for example, batteries. The first selection of types for the system will only permit the remote control of all tiles in uniform color, such that the tiles are placed on the roof in the appropriate design, while other types will also be offered that light up in any color and pattern, or that can be made to display text, either at night, or during the day. The energy used to light the individual color or black-and-white light-emitting solar roofing units is provided by electric power controlled by electric impulse either digitally addressed and transmitted centrally through an inverter, or transmitted through an individual electronic control unit. Said control can be: Wi-Fi, Bluetooth, Android, Infra, or remote radio, or via a PC, tablet, or smart phone using a special control program or application. The control programs can be made compatible with any operating system or smart phone application used world-wide, including Windows, Macintosh, Android, Apple, DOS, etc., for which purpose a special program (Light-Roof Software) has been developed.

The electric power-generating surface can consist of crystalline (mono- or polycrystalline), amorphous/thin film, or non-crystalline solar cells (photovoltaic gel or paint) structured in one or multiple layers so as to cover the entire surface of the roofing unit and to conform to its particular surface geometry.

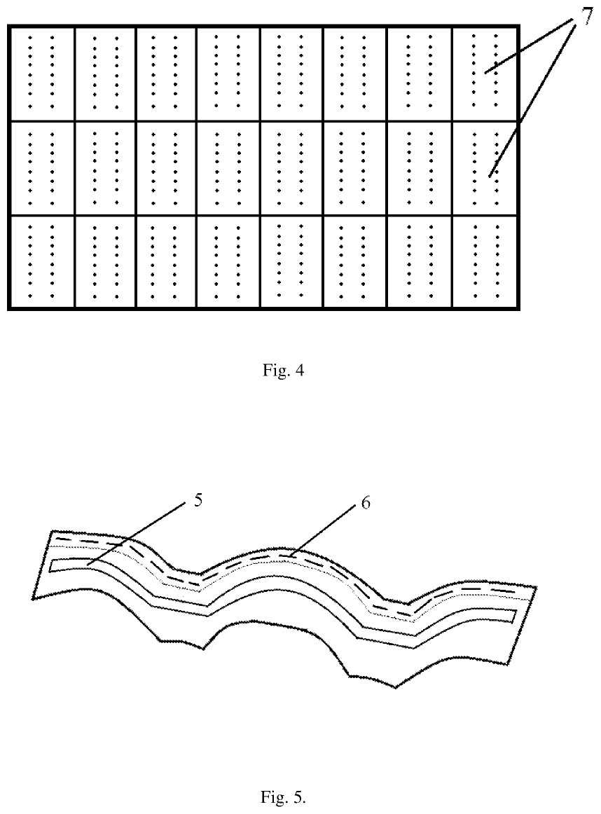

The solar-powered roofing units include a heat insulation layer incorporated into the primary body, making the new solar roofing tiles fire proof and imbuing them with good heat-insulating properties. In this way, the system functions as a first-tier heat-insulating roof covering within the overall roofing structure, thus saving on the additional heating or cooling costs associated with liveable attic spaces. See FIGS. 1 and 5.

A further embodiment of the invention, one that forms a separate line of products and something of a special application is, in essence, able—via the edges and surfaces of the transparent layers found in the embodiment and their bright LEDs—to light up in various colors, and in doing so, to transform the solar roofing units placed adjacent to one another over the entire roof surface into a giant pixel display for light, images, and text. The roofing units function as active imaging points (pixels) that can be controlled by computer, using software developed for the purpose. Data transmission for the computer program can be accomplished using a frequency controlled transmission system over the existing connections. In this case, each solar tile includes a microchip which interprets and identifies the digital signals. In this particular embodiment, each Solar Tile (roofing unit) generates the required electric energy during the day, then uses it at night to power the advertisement/display. The embodiment may be used with a Solar Roofing System of any form, size, or structure.

By combining colors of light, images and text can be created on each roof surface, which in turn are operated individually by the user. See FIG. 4.

The physical properties of the process according to this invention and individual steps involved are demonstrated below:

A given unit of flat space (say 45×55 mm) offers room for a total of, say, 4 pieces of 8″ (200×200 mm), 6 pieces of 6″ (156×156 mm), or 8 pieces of 4″ (100×100 mm) square silicon crystal wafers. Any configuration can be used, but these three sizes represent the selection of square solar cells in the world today, i.e. the sizes in which they are currently manufactured. These ready materials are used to create the present invention. The nominal voltage of a single fragile, flat, square silicon wafer is just 0.56 V (0.52-0.58V, depending on the type), a potential difference that is low for the electrical output of the product according to this invention, its physical parameters, and its usability as a product. If inflexible factory solar cells were used without transforming them, processing them, or connecting them electronically (on the surfaces of flat tiles only), only 2-4 V DC could be produce, rendering them non-functional in effect. This novel solution with its electrical properties and output can be attained if the factory (4″, 6″, and 8″) silicon crystals are sliced, using an appropriate device, technology, and machine, into strips, then connected physically and electrically (in series) so that as large a DC voltage is produced as possible over the flat and/or non-flat roofing units. The sliced silicon crystal strips (wafers) would have thicknesses between 2 mm and 18 mm, as desired, depending on what type and geometric shape of solar (photovoltaic) roofing unit is to be produced. It is important to note that from the electric standpoint (physical property), the higher the DC voltage produced with a given product, the smaller the electrical loss, and the higher the invention's nominal efficiency. While the given unit of flat surface (such as the 45×55 mm patch mentioned above) can produce approx. 2-8 V DC, the new technical solution described above can be used to increase the nominal voltage with 12-45 V DC per unit for flat roofing tiles. For non-flat types (with concave/convex surfaces), the increase per unit of surface area as compared to flat surfaces or flat solar cells is 20-45%. This means that with curved-surface new generation roofing tiles such as these, the nominal DC produced is 20 to 45 percent greater. That is, in this case, for radically/highly curved types, the measurable, DC output represents an increased value of approx. 17.5-65 V per unit, as a consequence of which certain roofing units will offer significantly improved performance. As a result, primarily with curved products, the electrical energy produced over, say, 1 m² of electrical surface is 20-45% higher than it is with flat solar panels. Because of this, with the purchase of products according to this invention, users will achieve a greater power yield, while the time to recovery of the purchase price of an entire system will be significantly shorter (6 years, as compared to the 8-12 years typical with flat solar panels). This explains why it is necessary to physically divide fragile, flat solar crystals (photovoltaic cells) into several parts, joined together via non-detachable (permanent) electrical connections (typically by welding) into an electrical series.

In another embodiment of this invention, the size of the roofing units is multiplied in the horizontal or vertical direction. In the event more than one piece is manufactured in one unit (e.g. 2, 3, 5, and 6 units manufactured as one piece), that is, as if several products were assembled or connected after-the-fact, then naturally, in accordance with a multiple multiplication of the 45-65 V DC produced by a single unit of the roofing product, for a set of, say, units 2, 3, 5, and 6 (consisting of several curved surfaces), the nominal voltage achieved could be as large as, say, 130-400 V DC.

The advantages of the invention are summarized as follows:

This invention pertains to a compatible, universal, next-generation, interactive solar roofing system that economically generates electric power from an external light source, along with the process used to accomplish this, which process arose from the continued development of earlier systems and the elimination of their deficiencies, different from any other known methods, focusing on the external size of the tile, it is manufactured to the external dimensions of many world known tile varieties. By methods of the present invention, roof tiles are created with solar cells that are fully compatible with the original, normal roof tiles, and can be easily replaced at the site by replacing the existing tiles without any technical intervention in the roof structure, and are considerably more advanced than the solutions given by earlier publications in terms of efficiency, construction, and functionality alike.

With solutions that enhance the output of its solar roofing units, the universal, next-generation, interactive electric roofing system operates economically and pays for itself in a considerably shorter time than has been achieved with previous systems—specifically, in 6 years.
The system is suited to producing electric power economically from external light sources, natural light (sunlight), artificial light, heat, or cosmic radiation;
Its individual units are safe and are furnished with joints and shock-protected contacts that meet current standards. The invention represents a new, module-based, compatible, universally configurable, eco-design lighting and electronic system, including a variety of sub-units, that utilizes a fully renewable energy source, independent of the external grid to which the building/structure is connected;
The system is able, utilizing the electric power it collects and stores itself, to emit white or colored light over each entire solar-powered roofing unit (or part thereof), where the light-emitting unit is preferably a LED or neon, fluorescent, or incandescent light;
The invention can be rounded out with a number of new, expandable functions, and offers a range of applications to suit the requirements of the modern age;
The units are furnished with integrated active or passive cooling abilities in the interest of improved efficiency.

1. Compatible, universal, next-generation interactive solar roof tile system for the economical production of electric energy from an external light source in such a way that the flat surface of the roof tile body (1) has a solar layer (6) containing solar cells, the solar layer (6) is covered with a sun-permeable protective layer (8), the solar cells are equipped with integrated conductors (2) and connectors (4),
characterised in that
the outer dimensions of the roof tile are compatible with those of the majority of previously produced tiles, it has a substrate tile body (1) manufactured according to the desired shape and size, its heat and frost-resistant basic material is made of non-combustible composite or recycled materials or a combination of those, on flat surfaces and on convex or concave surfaces the solar cells and solar layers (6) are series or parallel connected in the form of strips with standards-compliant conductors and electric shock-protected connectors, as well as the substrate tile body (1) has a fixed on fire resistant heat-insulating layer (5), and the solar cell layers (6) are connected to an interactive, integrated LED lighting device (7) equipped with a control unit to allow displaying of images, advertising signages and digital visualisation.

2. The solar roof tile according to claim 1, characterized in that the basic materials of the roof tile are any mineral oil derivative, plastic, resin and any variants thereof combined with any mineral material (sand, ground rock), glass fibre, carbon fibre, or ground glass.

3. The solar roof tile according to claim 1, characterized in that the sunlight-permeable protective layer (8) is a weather/heat/frost resistant transparent film which is fixed on the tile body (1) equipped with solar cells.

4. The solar roof tile according to claim 1, characterized in that a pocket (3) is moulded in the substrate tile body (1) to accommodate the connectors (4) and control electronics.

5. The solar roof tile according to claim 1, characterized in that the roof tile is controlled via WI-FI, Bluetooth, Android, infra, remote radio control or PC, tablet and smartphone.

6. The solar roof tile according to claim 1, characterized in that silicon PV strips integrated in the ribs of corrugated surfaces of the roof tiles are connected to each other in series with preferable soldering, thus forming a complete, single electric power supply surface in the new generation solar roof tile, and thereby increasing the voltage of each cell.

7. The solar roof tile according to claim 1, characterized in that a malfunction indicator light is integrated in the tile body (1) and/or in the protective layer (8).
